(19) United States
(12) Patent Application Publication
(10) Pub. No.: US 2012/0124632 A1
(43) Pub. Date: May 17, 2012

(54) SYSTEMS AND METHODS FOR CUSTOMIZING CHANNEL MAPS

(75) Inventors: Keith Alan Rothschild, Dunwoody, GA (US); Julius Bert Bagley, Lawrenceville, GA (US)

(73) Assignee: COX COMMUNICATIONS, INC., Atlanta, GA (US)

(21) Appl. No.: 12/944,893

(22) Filed: Nov. 12, 2010

(51) Int. Cl. H04N 7/173

(52) U.S. Cl. 725/114

(57) ABSTRACT

Systems and methods for modifying channel maps are provided. A predetermined channel map for a customer of a service provider may be identified. The predetermined channel map may include information mapping at least one of frequencies and program identifiers included in a broadband communications signal to a plurality of channels. The broadband communications signal may be output by the service provider. Based upon information associated with the customer, the predetermined channel map may be modified. Information associated with the modified channel map may then be output for communication via a service provider network to a programming processing component associated with the customer.

### FIELD OF THE INVENTION

Aspects of the invention relate generally to channel maps for television service and more particularly to customizing channel maps.

### BACKGROUND OF THE INVENTION

A wide variety of service providers, such as cable providers and satellite providers, provide broadband communications services, such as television services, to customers. Once a broadband signal is received by a customer device associated with a customer of a service provider, a virtual channel map or virtual channel table is typically utilized to map frequency ranges and/or program identifiers of the broadband signal to particular channels. For example, channel one may be mapped to a first frequency range of the broadband signal, channel two may be mapped to a second frequency range, and so on. As another example, if multiple channels are multiplexed to the same frequency, a virtual channel map is utilized to map frequency ranges and program identifiers to particular channels.

In conventional systems, a virtual channel map is typically assigned by a service provider to each customer reception device based on a level of the customer's subscription and the customer's location. The subscription level is typically utilized to remove channels that are not included in a subscription plan. The customer's location is typically utilized to determine what information, such as local channels, is available for the customer. Once a virtual channel map has been assigned, an identifier of the channel map is communicated to the customer reception device. The channel map itself is typically broadcast in a spooled or repeated message, and the customer reception device utilizes the identifier to pull appropriate channel map information from a broadband signal.

As the range of services offered by service providers increases, the process of broadcasting channel maps in a repeated message is losing efficiency. Scaling issues arise as more and more channel maps are utilized. Additionally, many customers wish to customize or personalize their channel maps, which is not accommodated by conventional systems. Further, limitations associated with the available channels maps may limit channel assignments made by the service provider. Accordingly, improved systems and methods for customizing channel maps are desirable.

### BRIEF DESCRIPTION OF THE INVENTION

Some or all of the above needs and/or problems may be addressed by certain embodiments of the invention. Embodiments of the invention may include systems, methods, and apparatus for modifying channel maps. In one embodiment, a system that facilitates the modification of channel maps may be provided. The system may include at least one memory and at least one processor. The at least one memory may be configured to store computer-executable instructions. The at least one processor may be configured to access the at least one memory and execute the computer-executable instructions to: (i) identify a predetermined channel map for a customer of a service provider, the predetermined channel map comprising information mapping frequencies and/or program identifiers included in a broadband communications signal output by the service provider to a plurality of channels, (ii) modify, based upon information associated with the customer, the predetermined channel map, and (iii) direct the output of information associated with the modified channel map for communication via a service provider network to a programming processing component associated with the customer.

In accordance with another embodiment of the invention, a method for modifying a channel map may be provided. Information associated with a predefined channel map for a customer of a service provider may be identified by a profile server associated with the service provider. The profile server may include one or more computers. Additionally, the predefined channel map may include information mapping at least one of frequencies and program identifiers included in a broadband communications signal to a plurality of channels. The broadband communications signal may be output by the service provider. Information associated with a customer request to modify the predefined channel map may be received by the profile server, and the profile server may modify the predetermined channel map based at least in part upon the received information. The profile server may then output, for communication via a service provider network to a programming processing component associated with the customer, at least an identifier of the modified channel map.

In accordance with yet another embodiment of the invention, a method for modifying a channel map may be provided. Information associated with a predefined channel map for a customer of a service provider may be identified by a profile server associated with the service provider. The profile server may include one or more computers. Additionally, the predefined channel map may include information mapping at least one of frequencies and program identifiers included in a broadband communications signal to a plurality of channels. The broadband communications signal may be output by the service provider. Based at least in part upon one of (i) demographic information associated with the customer or (ii) historical information associated with the customer, the predefined channel map may be modified by the profile server. The profile server may then output, for communication via a service provider network to a programming processing component associated with the customer, at least an identifier of the modified channel map.

Additional systems, methods, apparatus, features, and aspects may be realized through the techniques of various embodiments of the invention. Other embodiments and aspects of the invention are described in detail herein with reference to the description and to the drawings and are considered a part of the claimed invention.

### BRIEF DESCRIPTION OF THE DRAWINGS

Reference will now be made to the accompanying drawings, which are not necessarily drawn to scale, and wherein:

FIG. 1 illustrates a block diagram of an example system that may be utilized to facilitate the modification, customization, and/or personalization of customer channel maps, according to an illustrative embodiment of the invention.

FIG. 2 is a diagram of an example data flow for modifying a channel map, according to an illustrative embodiment of the invention

FIG. 3 is a flow diagram of an example method for modifying and outputting channel map information, according to an example embodiment of the invention.

FIG. 4 is a flow diagram of an example method for modifying a channel map in response to a user request, according to an example embodiment of the invention.

FIG. 5 is a flow diagram of an example method for modifying a channel map based at least in part upon historical information and/or demographic information associated with a customer, according to an example embodiment of the invention.

### DETAILED DESCRIPTION

Embodiments of the invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Embodiments of the invention may include systems and methods for modifying, customizing, and/or personalizing virtual channel maps or virtual channel tables. In certain embodiments, a profile server may be associated with a service provider, such as a cable service provider or a satellite service provider. The profile server may be a suitable processor-driven device or system configured to modify, customize, and/or personalize channel maps for various customers or subscribers of the service provider. A channel map may include information utilized by a programming processing component (e.g., a set-top box) of a customer to map or correspond various frequencies or ranges of frequencies included in a broadband signal (e.g., a cable signal, a satellite signal, etc.) and/or various program identifiers included in the broadband signal (e.g., program numbers, MPEG numbers, etc.) to a plurality of channels. As desired, a wide variety of parameters, options, and/or customer preferences may be utilized to modify a predetermined or pre-existing channel map for a customer.

In one example embodiment, the profile server may identify a predetermined channel map for a customer. The predetermined channel map may be either a default channel map for the customer or a channel map that has previously been modified and/or stored. In certain embodiments, a default channel map for the customer may be identified and/or generated based at least in part upon information received from a billing system of the service provider. For example, a default channel map for the customer may be generated based upon a customer's location and/or subscription level. In other embodiments, a predetermined channel map for the customer may be accessed from a suitable memory associated with the profile server. For example, a stored database that includes user profile and/or user channel map information may be accessed.

Once a predetermined channel map has been identified, the profile server may modify the channel map in order to generate a modified channel map for the customer. A wide variety of suitable techniques may be utilized to modify a channel map. In certain embodiments, a channel map may be modified based upon demographic and/or historical information associated with the customer. In this regard, a version of a channel and/or a type of channel that is referenced by the channel map may be modified. For example, demographic information (e.g., customer location, median household income associated with a customer location, gender, etc.) may be utilized to generate an advertisement profile for the customer and/or to select a version of a channel having inserted advertisement information that best matches the demographic information associated with the customer. As another example, customer viewing history, pay-per-view purchase history, and/or other historical information associated with the customer may be utilized to generate and/or update an advertisement profile for the customer. Versions of channels may then be selected based upon the historical information and/or advertisement profile. As desired, channel map modification based upon demographic and/or historical information may be transparent to the user.

In other embodiments, a channel map may be modified based upon one or more requests received from a customer. A wide variety of different types of customer requests may be received as desired in various embodiments of the invention. For example, a customer may request modified organization (e.g., grouping, order, etc.) of channels included in a channel map, modified channel number assignments, modifications to the channels displayed in a channel map, etc. Additionally, customer requests may be received utilizing a wide variety of suitable techniques. In certain embodiments, customer requests may be entered into a programming processing component and communicated to the profile server via a suitable service provider network. In other embodiments, a customer may utilize a suitable customer device (e.g., a mobile device, a personal computer, etc.) to access a Web server hosted by the service provider, and customer requests may be received via an established communications session.

In yet other embodiments, a channel map may be modified based upon both received customer input and/or stored information associated with a customer. For example, a customer may be given one or more options to opt in or opt out of certain advertisement profiles. As one example, a customer may be permitted to select the types of advertisement data that he or she wishes to receive. Channel versions may then be selected in part upon the customer preferences and/or other information associated with the customer, such as demographic and/or historical information.

As desired in various embodiments, a channel map may be modified for a customer at a wide variety of different levels. For example, a channel map may be modified for all of the programming processing components (e.g., set-top boxes) associated with a customer or customer account. As another example, a channel map may be modified for an individual programming processing component. As yet another example, a channel map may be modified for a particular individual associated with a customer account. In this regard, an individual may be identified by a programming processing component, for example, by providing identification information and/or access credentials to the programming processing component. Once identified, a personalized channel map for an individual may be utilized.

Following the modification of a channel map, information associated with the channel map may be output for communication to one or more programming processing components associated with the customer. For example, information associated with a modified channel map may be output by the profile server for communication to one or more programming processing components via a service provider network. In certain embodiments, the channel map or modifications to a channel map may be communicated directly to a programming processing component. In other embodiments, a channel map may be inserted into a broadband signal, and an identifier of the channel map may be communicated to a programming processing component. In this regard, the programming processing component can extract the appropriate channel map from the broadband signal. Additionally, as desired, information associated with a channel map may be output in response to a received request for the information. For example, a channel map request may be received from a programming processing component, and information associated with the channel map may be output in response to the received request.

System Overview

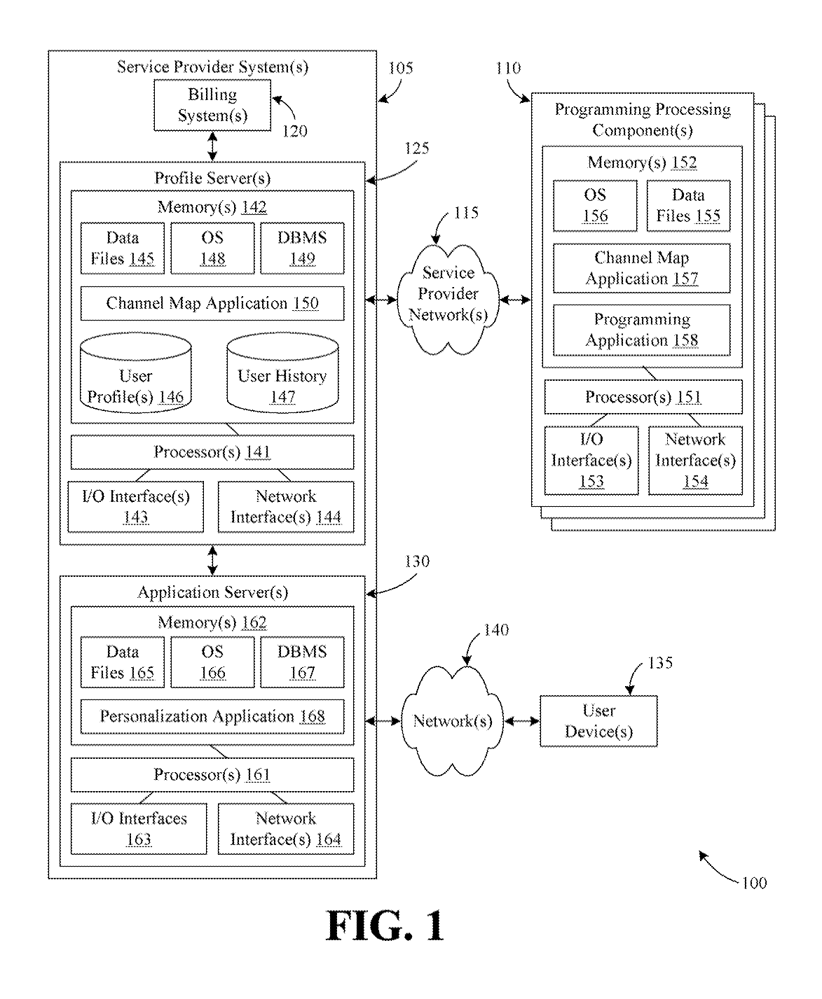

An example system 100 for modifying, personalizing, and/or customizing a customer channel map will now be described illustratively with respect to FIG. 1. The system 100 may include, for example, one or more service provider systems 105 and/or any number of programming processing components 110. Any number of suitable service provider networks 115 (e.g., cable networks, satellite networks, etc.) may facilitate communications between the service provider systems 105 and the programming processing components 110. A service provider system may include any number of suitable components or subsystems, such as one or more billing systems 120, one or more profile servers 125, and/or one or more application servers 130. In certain embodiments, one or more user devices 135 may be configured to communicate with the application servers 130 via any number of suitable networks 140.

As desired, one or more components of the system 100 may be processor-driven components or devices. In this regard, certain components of the system 100 may be configured for accessing and reading associated computer-readable media having stored thereon data and/or computer-executable instructions for implementing the various methods of the invention. Additionally, in certain embodiments, certain components of the system 100 may be combined. For example, a profile server 125 and an application server 130 may be combined into a single server.

With reference to FIG. 1, the service provider system 105 may include any number of systems and/or devices that facilitate the output of a broadband signal for receipt by any number of programming processing components 110. For example, the service provider system 105 may include systems associated with a cable service provider, a satellite service provider, or other service provider. In operation, the service provider system 105 may receive content from one or more content providers, format content for output in a broadband signal, and/or output the broadband signal. Examples of suitable systems that may be associated with the service provider system 105 include, but are not limited to, a service provider head-end component, a conditional access system controller, any number of encryption devices, an electronic program guide data server, an on-demand server, a pay-per-view purchase server, etc.

In certain embodiments, the service provider system 105 may include one or more billing systems 120. A billing system 120 may be a suitable device, server, and/or component of the service provider system 105 that facilitates the identification of a customer account (e.g., a customer billing account with a service provider) associated with a customer and/or the programming processing components for a customer. The billing system 120 may be a suitable processor-driven device that is configured to execute computer-readable, computer-implemented, or computer-executable instructions. The execution of suitable computer-implemented instructions by the billing system 120 may form a special purpose computer or other particular machine that is operable to facilitate the identification or access of customer account information associated with a customer of the service provider. A wide variety of customer account information may be identified by the billing system 120, such as information associated with one or more programming processing components 110 for a customer (e.g., device types, device capabilities, device identifiers, etc.), customer location information (e.g., address, ZIP code, etc.), and/or subscription level information for the customer. Once customer account information has been identified or accessed, the billing system 120 may communicate the customer account information to the profile server 125 to facilitate the generation of a channel map for the customer. In certain embodiments, information may be communicated to the profile server 125 in response to a request for the information that is received from the profile server 125. In other embodiments, information may be pushed to the profile server 125 absent the receipt of a request for the information.

With continued reference to FIG. 1, any number of profile servers 125 may be associated with the service provider system 105. A profile server 125 may be a suitable processor-driven device configured to generate and/or modify channel maps for one or more customers of the service provider. For example, the profile server 125 may customize or personalize virtual channel maps. Examples of suitable processor-driven devices that may be utilized as a profile server 125 include, but are not limited to, a personal computer, a digital assistant, a personal digital assistant, a digital tablet, an Internet appliance, an application-specific circuit, a microcontroller, a minicomputer, or any other processor-based device. The execution of suitable computer-implemented instructions or computer-executable instructions by the profile server 125 may form a special purpose computer or other particular machine that is operable to facilitate the modification, customization, and/or personalization of channel maps.

The profile server 125 may include one or more processors 141, one or more memory devices 142, one or more input/output (“I/O”) interfaces 143, and/or one or more network interfaces 144. The processor(s) 141 may be configured to execute any number of software applications and/or computer-readable or computer-executable instructions. The memory devices 142 may include any number of suitable memory devices, such as caches, read-only memory devices, random access memory devices, magnetic storage devices, etc. The memory devices 142 may store data, executable instructions, and/or various program modules utilized by the processor(s) 141. Examples of data that may be stored by the memory devices 142 include data files 145 and/or any number of suitable databases, such as user profile databases 146 and/or user history databases 147. Additionally, the memory devices 142 may be configured to store any number of suitable program modules that may be executed by the processor(s) 141, such as an operating system (“OS”) 148, a database management system (“DBMS”) 149, and/or a channel map application 150.

The data files 145 may include any suitable data that facilitates the operation of the profile server 125 and/or the modification, customization, or personalization of channel maps. For example, the data files 145 may include, but are not limited to, information that facilitates communication with any number of programming processing components 110, information associated with default channel maps, information associated with various versions of channels, and/or information associated with advertising profiles. The user profile database 146 may include a wide variety of demographic information associated with users (e.g., user location information, average income information for a geographical area, gender information, etc.) and/or user preferences and/or parameters associated with the generation and/or modification of channel maps, such as advertisement opt in and/or opt out information, channel organization preferences, preferences associated with displaying or hiding channels, channel assignment number preferences, preferences associated with channel versions, etc. The user history database 147 may include historical information associated with services provided to the user, such as information associated with a user's viewing history and/or purchasing history with the service provider.

The OS 148 may be a suitable software module that controls the general operation of the profile server 125. The OS 148 may also facilitate the execution of other software modules, for example, the DBMS 149 and/or the channel map application 150. The DBMS 149 may facilitate the management and/or access of information included in the one or more databases 146, 147. As desired, the profile server 125 may additionally include one or more host modules that facilitate the establishment of a communications session with one or more programming processing components 110 and/or user devices 135. In this regard, the profile server 125 may receive one or more user requests and/or preferences associated with modifying channel maps.

The channel map application 150 may be a suitable software module or software application that is configured to modify, customize, and/or personalize channel maps for any number of customers and/or programming processing components 110. In operation, the channel map application 150 may identify or access a predetermined channel map for a customer. In certain embodiments, the identification of a predetermined channel map may include the identification and/or generation of a default channel map for a customer. For example, a default channel map may be identified and/or generated based upon customer account information (e.g., customer location information, subscription level information, etc.) received from a billing system 120. As another example, a stored default channel map for a customer may be accessed from a user profile database 146 or other memory location. In other embodiments, the identification of a predetermined channel map may include the identification of a customized or personalized channel map that is stored in association with a customer.

Once channel map information has been identified, the channel map application 150 may modify the identified channel map information. A wide variety of suitable methods and/or techniques may be utilized to modify channel map information for a customer. As one example, channel map information may be modified based upon demographic information (e.g., geographic median income information, gender information, advertising demographic information, etc.) and/or historical information associated with a customer (e.g., viewing history, purchasing history, etc.). As another example, channel map information may be modified based upon one or more received customer requests and/or preferences. In certain embodiments, a customer may enter requests and/or preferences into a programming processing component 110, and the programming processing component may communicate the requests and/or preferences to the service provider system 105 via any number of service provider networks 115. In other embodiments, a customer may utilize a suitable user device 135, such as a personal computer or a mobile device, to access a site (e.g., a Web site) hosted by the service provider, such as a site hosted by a suitable application server 130. A communications session may be established between the user device 135 and the application server 130 via any number of suitable networks 140, such as a suitable wide area network (e.g., the Internet), a cellular network, a Wi-Fi enabled network, or any other suitable network. Customer preferences and/or requests may be received by the application server 130 via the site, and the received preferences and/or requests may be provided to the profile server 125. Alternatively, in certain embodiments, the profile server 125 may include functionality that facilitates communication with user devices 135.

As desired in various embodiments, a wide variety of different modifications may be made to a customer channel map. Certain modifications may be made without receiving customer input. Other modifications may be based at least in part on received customer input. As one example modification, a version of a channel referenced by a channel map may be modified. For example, several versions of a particular channel may be available for provision to a customer. Different versions of the channel may include different advertisements (e.g., advertisements inserted by the service provider), different codecs, different formats (e.g., high definition, etc.), and/or different source constructs (e.g., IP multicast address, frequency and MPEG number, etc.). Based upon customer-specific information, such as capabilities of a customer programming processing component 119, customer viewing history, advertisement opt in and/or opt out preferences, and/or demographic information, a particular version of a channel may be selected and included in a channel map for the customer. As another example of modifying a channel map, a channel map may be personalized based upon customer preferences. For example, the layout, listed or viewable channels, and/or channel number assignments may be modified based upon received customer requests.

According to an aspect of the invention, a channel map may be modified and/or customized for a wide variety of different scopes associated with a customer. In certain embodiments, a channel map may be modified for all of the programming processing components 110 associated with a customer or customer household. In other embodiments, a channel map may be modified for a particular programming processing component 110 or a group of programming processing components 110 associated with a customer. For example, a customer may specify that adult channels are only included in a channel map associated with a programming processing component 110 situated in a bedroom, while the channels are not included in a channel map for other programming processing components. In yet other embodiments, a channel map may be modified for a particular individual associated with a customer account. In this regard, different channel maps may be associated with different individuals within a household. A programming processing component 110 may access an appropriate channel map based upon an identification of an individual, such as an identification based upon receiving a user name and/or access credentials, an identification based upon voice recognition, and/or any other suitable identification.

Once a channel map has been modified by the channel map application 150, information associated with the modified channel map may be output by the profile server 125 for communication to one or more programming processing components 110 associated with the modified channel map. For example, information associated with the modified channel map may be communicated to a programming processing component 110 via a suitable service provider network 115. In certain embodiments, channel map information may be communicated once a modification is made. In other embodiments, channel map information may be periodically communicated to a programming processing component 110 (e.g., once a day, once a week, etc.). In yet other embodiments, channel map information may be communicated in response to receiving a request for the channel map information from a programming processing component 110. As desired, a wide variety of different types of channel map information may be output for communication to a programming processing component. For example, in certain embodiments, an entire channel map or information that may be utilized to construct the channel map may be output. In other embodiments, information associated with modifications to be made to a preexisting channel map stored by a programming processing component 110 may be output. In yet other embodiments, an identifier for a channel map may be output for communication to a programming processing component 110. The identifier may be utilized by the programming processing component 110 to identify and extract a channel map from a broadband signal.

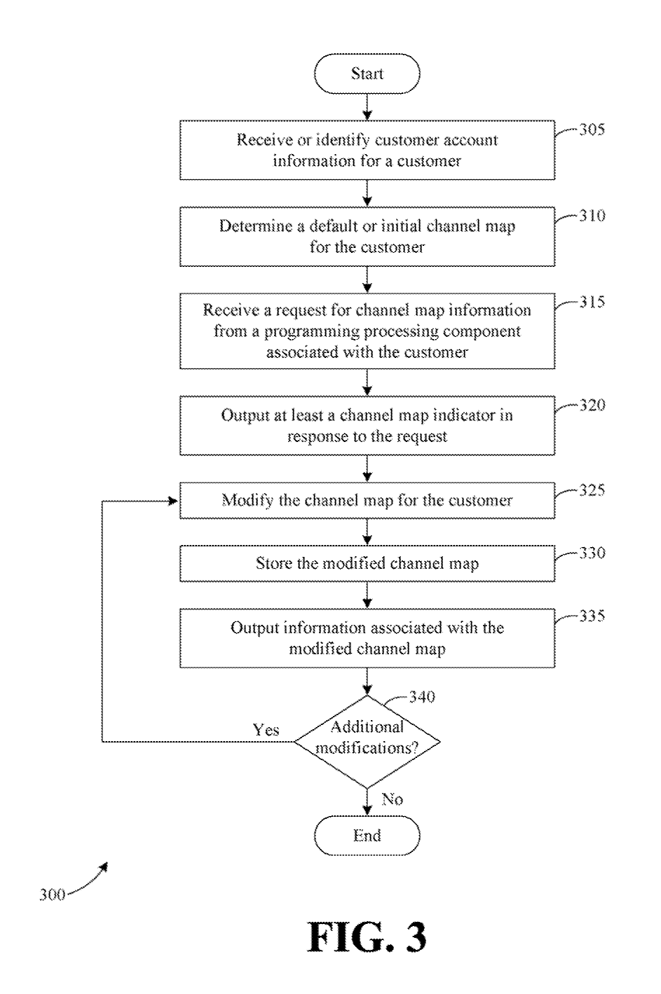

The operations for the channel map application 150 described above are provided by way of example only. A wide variety of other operations may be performed by the channel map application 150 as desired in various embodiments of the invention. Other examples of the operations that may be performed by the channel map application 150 are described in greater detail below with reference to FIGS. 3-5.

With continued reference to the profile server 125, the one or more I/O interfaces 143 may facilitate communication between the profile server 125 and one or more input/output devices, for example, one or more user interface devices, such as a display, keypad, mouse, pointing device, control panel, touch screen display, remote control, microphone, speaker, etc., that facilitate user interaction with the profile server 125. In this regard, user commands may be received by the profile server 125. The one or more network interfaces 144 may facilitate connection of the profile server 125 to one or more suitable networks, for example, a broadband network or service provider network (e.g., a cable network, a satellite network, etc.), such as the service provider networks 115 illustrated in FIG. 1. In this regard, the profile server 125 may communicate with one or more programming processing components 110, receive consumer requests, and/or communicate information associated with modified channel maps.

With continued reference to FIG. 1, any number of programming processing components 110 may be provided. Each programming processing component 110 may be a suitable device or component that facilitates the receipt, processing, and/or output of at least one broadband signal, such as a broadband cable signal or a broadband satellite signal. Additionally, a programming processing component 110 may facilitate the identification and/or storage of virtual channel map or virtual channel table information, as well as the processing of the channel map information to map various components of the at least one broadband signal to a plurality of channels. In certain embodiments, the programming processing component 110 may be a customer premise device or component that is situated within a customer's household or other structure associated with the customer. The programming processing component 110 may include suitable hardware and/or software components capable of receiving and processing a broadband signal (e.g., a cable signal, a satellite signal, etc.) output by a service provider system 105, such as a cable service provider system or a satellite service provider system. Examples of suitable programming processing components include, but are not limited to, a set-top box (“STB”) (e.g., a cable STB, a digital satellite STB, an Internet Protocol Television STB, etc.), a virtual STB, an embedded STB, etc.

In certain embodiments, the programming processing component 110 may be connected to one or more display devices, such as a television, associated with a customer. In other embodiments, the programming processing component 110 may be embedded, incorporated into, and/or executed on a display device. In operation, the programming processing component 110 may receive at least a portion of a broadband data signal output by the service provider system 105, and the programming processing component 110 may convert at least a portion of the received signal into content which is displayed or otherwise output by the display device. In doing so, the programming processing component 110 may utilize channel map information to identify portions of the received signal corresponding to various channels that are selectable and viewable by a user. As desired, the programming processing component 110 may receive a broadband data signal via any number of suitable service provider networks 115, such as a cable network that includes any number of optical fibers, coaxial cables, and/or cable drops, a satellite network that includes a suitable satellite dish and/or connecting cables, and/or other suitable networks. Additionally, any number of intermediary devices, such as broadband modems, routers, etc., may be situated between the service provider system 105 and the programming processing component 110.

The programming processing component 110 may be a suitable processor-driven device that facilitates the receipt, processing, and/or output of a broadband signal. In doing so, the programming processing component 110 may utilize virtual channel map information to identify various components of the broadband signal that correspond to a plurality of different channels. The programming processing component 110 may include any number of computing devices, such as a personal computer, a digital assistant, a personal digital assistant, a digital tablet, an Internet appliance, an application-specific circuit, a microcontroller, a minicomputer, or any other processor-based device. The execution of suitable computer-implemented instructions or computer-executable instructions by the programming processing component 110 may form a special purpose computer or other particular machine that is operable to facilitate the identification of virtual channel map information and the output of broadband content in accordance with the identified virtual channel map information.

With reference to FIG. 1, the programming processing component 110 may include one or more processors 151, one or more memory devices 152, one or more input/output (“I/O”) interfaces 153, and/or one or more transceivers and/or network interfaces 154. The processor(s) 151 may be configured to execute any number of software applications and/or computer-readable or computer-executable instructions. The memory devices 152 may include any number of suitable memory devices, such as caches, read-only memory devices, random access memory devices, flash memory devices, magnetic storage devices, removable storage devices (e.g., memory cards, etc.), etc. The memory devices 152 may store data, executable instructions, and/or various program modules utilized by the processor(s) 151. Examples of data that may be stored by the memory devices 152 include data files 155 and/or any number of suitable program modules that may be executed by the processor(s) 151, such as an operating system (“OS”) 156, a channel map application 157, and/or a programming application 158.

The data files 155 may include any suitable data that facilitates the operation of the programming processing component 110, the processing of a received broadband signal, and/or the processing of customer requests to modify a channel map. For example, the data files 155 may include, but are not limited to, user profile information, information associated with one or more channel maps, information associated with the profile server 125, and/or information associated with other service provider system components. The OS 156 may be a suitable software module that controls the general operation of the programming processing component 110. The OS 156 may also facilitate the execution of other software modules, for example, the channel map application 157 and/or the programming application 158.

The channel map application 157 may be a suitable software module or component that facilitates the mapping of various components included in a received broadband signal to a plurality of channels. In operation, the channel map application 157 may obtain a channel map to be utilized. In certain embodiments, the channel map may be accessed from memory. In other embodiments, the channel map may be extracted from the broadband signal utilizing a stored channel map identifier. As desired, a request for channel map information may be communicated to the profile server 125, and information received in response to the request may be utilized to identify or determine a channel map. Additionally, as desired, a channel map may be identified based upon an identity of a user of the programming processing component 110. Once a channel map has been identified, the channel map may be utilized to correlate components of the broadband signal, such as various frequency ranges and/or program identifiers (e.g., program numbers, MPEG numbers, packet identifiers, etc.) of the broadband signal, to a plurality of different channels. For example, channel one may be mapped to a first frequency range, channel two may be mapped to a second frequency range, and so forth. As another example, multiple digital channels may be multiplexed on a single frequency, and one or more program identifiers may be utilized in conjunction with the various frequency ranges to map the components of the broadband signal to various channels. When a customer selects a particular channel, the appropriate component of the broadband signal may be accessed, formatted for output, and output for presentation to the user. Additionally, in certain embodiments, the channel map application 157 may coordinate with an electronic programming guide application to facilitate the output of program guide information for presentation to a user.

In certain embodiments, the channel map application 157 may additionally facilitate the receipt of user requests and/or preferences associated with modifying and/or configuring a channel map. For example, the channel map application 157 may output any number of suitable graphical user interface screens that facilitate the collection of user requests and/or preferences. User requests and/or preferences may be entered via a suitable input device (e.g., remote control, etc.), and the user requests may be received by the channel map application 157 and output by the channel map application 157 for communication to the profile server 125. A wide variety of different types of user requests may be received and processed by the channel map application 157 as desired, such as customization requests and/or advertisement opt in and/or opt out requests.

A wide variety of suitable operations may be performed by the channel map application 157 as desired in various embodiments of the invention. The operations described above are provided by way of example only.

With continued reference to FIG. 1, the programming application 158 may be a suitable software module that facilitates the processing and/or output of received broadband content and/or stored broadband content. For example, the programming application 158 may be configured to format at least a portion of a received broadband signal and/or at least a portion of stored content for output by the programming processing component 110 and presentation via one or more display devices. A wide variety of content may be formatted for output by the programming application 158 as desired in various embodiments of the invention, including but not limited to, television content, audio content, VoIP telephone content, electronic program guide data, Internet and/or Web site content, etc. Additionally, the programming application 158 may be configured to receive and process user commands associated with the output of content. For example, the programming application 158 may be configured to process user commands received via remote control input and/or user voice commands.

With continued reference to the programming processing component 110, the one or more I/O interfaces 153 may facilitate communication between the programming processing component 110 and one or more input/output devices, for example, one or more user interface devices, such as a remote control, display, keypad, mouse, pointing device, control panel, touch screen display, microphone, speaker, etc., that facilitate user interaction with the programming processing component 110. In this regard, user commands may be received by the programming processing component 110. The one or more network interfaces 154 may facilitate connection of the programming processing component 110 to one or more suitable service provider networks 115 or broadband networks (e.g., a cable network or a satellite network). In this regard, the programming processing component 110 may receive a broadband signal for processing and output. Additionally, the programming processing component 110 may communicate commands and/or requests to the service provider system 105 and/or the profile server 125, and the programming processing component 110 may receive commands and/or information from the service provider system 105 and/or the profile server 125.

With continued reference to FIG. 1, any number of application servers 130 may be provided in association with the service provider. An application server 130 may be a suitable processor-driven device configured to receive consumer requests and/or preferences for modifying channel maps. For example, the application server 130 may receive information from one or more user devices 135. Examples of suitable processor-driven devices that may be utilized as an application server 130 include, but are not limited to, a personal computer, a digital assistant, a personal digital assistant, a digital tablet, an Internet appliance, an application-specific circuit, a microcontroller, a minicomputer, or any other processor-based device. The execution of suitable computer-implemented instructions or computer-executable instructions by the application server 130 may form a special purpose computer or other particular machine that is operable to facilitate the receipt of user requests and/or preferences associated with the modification, customization, and/or personalization of channel maps.

The application server 130 may include one or more processors 161, one or more memory devices 162, one or more input/output (“I/O”) interfaces 163, and/or one or more network interfaces 164. The processor(s) 161 may be configured to execute any number of software applications and/or computer-readable or computer-executable instructions. The memory devices 162 may include any number of suitable memory devices, such as caches, read-only memory devices, random access memory devices, magnetic storage devices, etc. The memory devices 162 may store data, executable instructions, and/or various program modules utilized by the processor(s) 161. Examples of information that may be stored by the memory devices 162 include data files 165 and/or various program modules, such as an operating system (“OS”) 166, a database management system (“DBMS”) 167, and/or a personalization application 168.

The data files 165 may include any suitable data that facilitates the operation of the application server 130 and/or the receipt and processing of customer requests and/or parameters for modifying a channel map. For example, the data files 165 may include, but are not limited to, information that facilitates communication with any number of user devices 135, information associated with any number of Web pages hosted by the application server 130, information associated with the profile server 125, and/or information associated with the databases 146, 147 associated with the profile server 125. The OS 166 may be a suitable software module that controls the general operation of the application server 130. The OS 166 may also facilitate the execution of other software modules, for example, the DBMS 167 and/or the personalization application 168. The DBMS 167 may facilitate the management and/or access of information included in one or more databases, such as the databases 146, 147 described above in association with the profile server 125. In certain embodiments, certain databases may be shared by components of the service provider system 105 and accessed by a plurality of different components. For example, the application server 130 may receive information from a user device 135 and update customer preferences stored in a database that is also accessible by the profile server.

The personalization application 168 may be a suitable software module or software application configured to receive and process user requests and/or parameters for modifying a channel map. As desired, the personalization application 168 may include one or more host modules or host components that facilitate the establishment of a communications session with one or more user devices 135. For example, the personalization application 168 may be configured to host any number of Web sites that may be accessed by a user utilizing a user device 135. In this regard, the personalization application 168 may receive one or more user requests and/or preferences associated with modifying channel maps. Once received, the personalization application 168 may update stored information associated with user profiles and/or user requests. Alternatively, the personalization application 168 may communicate information associated with received requests to the profile server 125.

With continued reference to the application server 130, the one or more I/O interfaces 163 may facilitate communication between the application server 130 and one or more input/output devices, for example, one or more user interface devices, such as a display, keypad, mouse, pointing device, control panel, touch screen display, remote control, microphone, speaker, etc., that facilitate user interaction with the application server 130. In this regard, user commands may be received by the application server 130. The one or more network interfaces 164 may facilitate connection of the application server 130 to one or more suitable networks, for example, a wide area network, the Internet, a cellular network, etc. In this regard, the application server 130 may communicate with one or more user devices 135.

Additionally, any number of user devices 135 may be utilized in association with the system 100. Examples of user devices 135 include, but are not limited to, personal computers, mobile devices, Internet appliances, etc. A user device 135 may be a suitable processor-driven device that permits a user to access one or more applications that allow the user to request modifications to a channel map. For example, a user may utilize a user device 135 to access a Web server, such as a Web server associated with the application server 130, that permits the user to request channel map modifications. Certain components of a user device 135 may be similar to the components described above for other components of the system 100. For example, a user device 135 may include any number of suitable processors, memory devices, I/O interfaces, and/or network interfaces that facilitate the access of a Web server and/or the communication of one or more user requests and/or preferences utilized to modify a channel map.

Communications between various components of the system 100 may be facilitated via any number of suitable networks, such as one or more service provider networks 115 (e.g., a cable network, a satellite network, etc.) and/or other networks 140, such as the Internet or other wide area network. The various networks may include any telecommunication and/or data networks, whether public, private, or a combination thereof, including but not limited to, a local area network, a wide area network, an intranet, the Internet, public switched telephone networks, satellite networks, cable networks, and/or any combination thereof and may be wired and/or wireless.

Those of ordinary skill in the art will appreciate that the system 100 shown in and described with respect to FIG. 1 is provided by way of example only. Numerous other operating environments, system architectures, and device configurations are possible. Other system embodiments can include fewer or greater numbers of components and may incorporate some or all of the functionality described with respect to the system components shown in FIG. 1.

Operational Overview

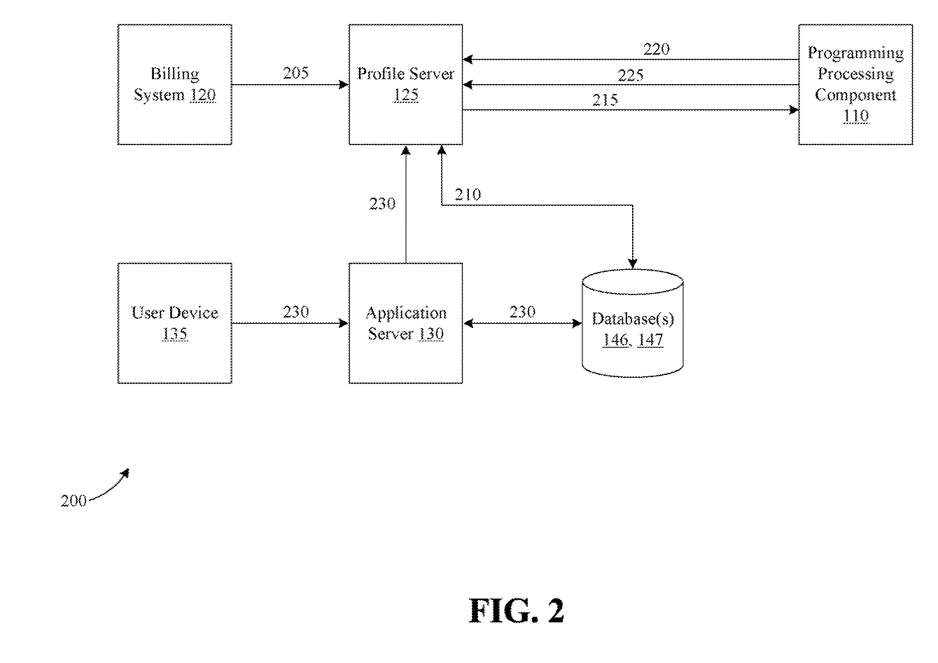

FIG. 2 is a diagram of an example data flow 200 for modifying a channel map, according to an illustrative embodiment of the invention. With reference to FIG. 2, customer account information 205 may be communicated from a billing system associated with a service provider, such as the billing system 120 illustrated in FIG. 1, to a profile server associated with the service provider, such as the profile server 125 illustrated in FIG. 1. The customer account information 205 may include a wide variety of information associated with a customer, such as one or more device identifiers for customer programming processing components, customer location information, and/or customer subscription level information. Once the customer account information 205 is received by the profile server 125, the profile server 125 may utilize the customer account information 205 to generate or identify a default channel map for the customer. As an alternative to generating or identifying a default channel, a preexisting channel map for the customer may be accessed from memory or obtained from any suitable data sources.

In certain embodiments, the default channel map or predetermined channel map may be modified or customized based at least in part upon customer-specific information. For example, stored user information 210, such as demographic information (e.g., advertisement demographic information, etc.) and/or viewing history information, may be accessed from one or more suitable databases, such as the databases 146, 147 illustrated in FIG. 1, or from any number of other data sources. The user information 210 may be utilized to perform any number of modifications to the channel map. For example, versions of certain channels referenced by the channel map may be modified. In this regard, advertisements associated with the channels may be more specifically targeted to the users. Additionally, various channel formats and/or source constructs may be modified.

Once the channel map has been modified, information 215 associated with the channel map, such as information that may be utilized to build the channel map and/or a channel map identifier, may be output by the profile server 125 for communication to one or more programming processing components associated with the user, such as the programming processing component 110 illustrated in FIG. 1. In certain embodiments, the channel map information 215 may be output based upon the receipt of a request 220 for the information 215 from the programming processing component 110. For example, a request 220 may be communicated from the programming processing component 110 either periodically (e.g., once an hour, once a day, etc.) or upon the identification of a predetermined event (e.g., turning on the device, identification of a user, etc.). In other embodiments, the channel map information 215 may be pushed to the programming processing component 110 without receiving a request 220 for the information.

Additionally, in certain embodiments, user requests and/or preferences may be received by the profile server 125, and one or more channel maps may be modified based at least in part upon the received user requests and/or preferences. A wide variety of different types of information may be received by the profile server as desired in various embodiments, including but not limited to, requests and/or preferences for customizing or personalizing a channel map (e.g., channel assignment, viewable channels, selectable channels, channel organization, etc.), advertisement preferences, and/or advertisement opt in and/or opt out information. In certain embodiments, information 225 associated with user requests and/or parameters may be received from the programming processing component 110 via a suitable service provider network. In other embodiments, information 230 associated with user requests and/or parameters may be received by the profile server 125 or a suitable application server, such as the application server 130 illustrated in FIG. 1, from a user device (e.g., a personal computer, a mobile device, etc.), such as the user device 135 illustrated in FIG. 1. For example, a user may utilize a suitable user device 135 to access one or more Web sites hosted by the application server 130, and user request information 230 may be communicated to the application server 130. Once received by the application server 130, the received information 230 may be stored in the databases 146, 147 by the application server 130 or, alternatively, communicated to the profile server 125 for processing.

Based upon received information 225, 230 associated with user requests and/or preferences for modifying a channel map, the profile server 125 may modify one or more preexisting or predetermined channel maps for the user. As desired, the modification of a channel map may be scoped to a user level, a programming processing level, and/or to a customer account or household level. Once the channel map has been modified, information 215 associated with the modified channel map may be output for communication to one or more programming processing components 110 in a similar manner as that described above.

It will be appreciated that variations of the data flow 200 illustrated in FIG. 2 may be utilized in accordance with various embodiments of the invention. The data flow 200 illustrated in FIG. 2 is provided by way of example only.

FIG. 3 is a flow diagram of an example method 300 for modifying and outputting channel map information, according to an example embodiment of the invention. In certain embodiments, the method 300 may be performed by a suitable service provider system and/or profile server, such as the service provider system 105 and/or profile server 125 illustrated in FIG. 1. The method 300 may begin at block 305.

At block 305, customer account information associated with a customer account may be received and/or identified. For example, customer account information may be received from a suitable billing system associated with the service provider system, such as the billing system 120 illustrated in FIG. 1. As another example, customer account information may be accessed from one or more suitable memory locations, such as a user profile database. Once customer account information has been identified, a default or initial channel map for the customer may be determined or generated at block 310. The default channel map may be determined based at least in part upon the customer account information. For example, the default channel map may be determined based at least in part upon location information and/or subscription level information associated with the customer.

At block 315, which may be optional in certain embodiments of the invention, a request for channel map information may be received from a programming processing component associated with the customer, such as the programming processing component 110 illustrated in FIG. 1. At block 320, information associated with the default channel map, such as information that may be utilized to generate the default channel map and/or an indicator of the default channel map, may be output for communication to one or more programming processing components 110 associated with the customer.

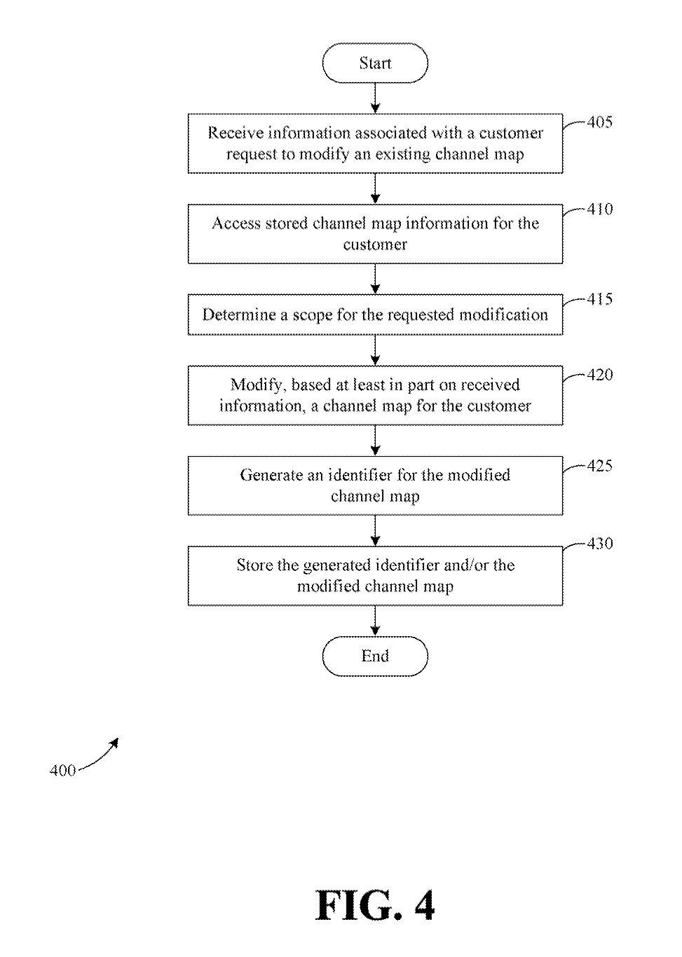

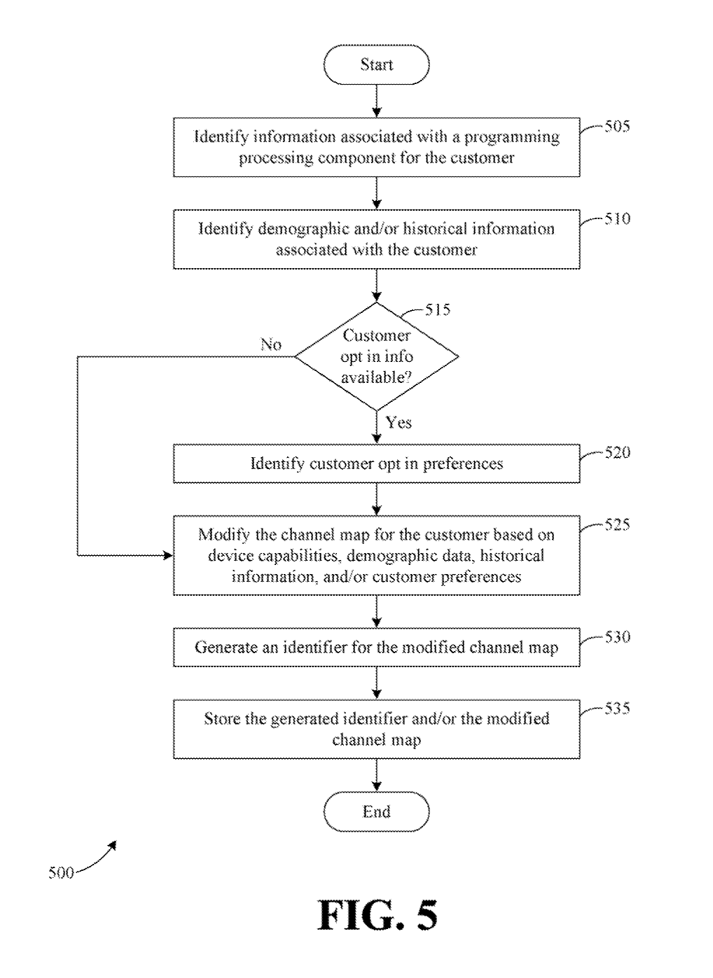

At block 325, the default channel map may be modified, customized, and/or personalized for the customer. As desired, a wide variety of suitable methods and/or techniques may be utilized to modify the default channel map (or any other preexisting channel map). For example, as explained in greater detail below with reference to the method 400 of FIG. 4, a channel map may be modified based at least in part upon one or more received user requests and/or preferences. As another example, as explained in greater detail below with reference to the method 500 of FIG. 5, a channel map may be modified based upon stored and/or collected information associated with the user, such as demographic information and/or historical information. Additionally, as desired, the modification of a channel map may be scoped to a wide variety of different levels, such as a customer account level, a programming processing component level, and/or an individual user level. In this regard, any number of channel maps may be generated and associated with a customer account.

Once a channel map has been modified at block 325, operations may continue at block 330. At block 330, the modified channel map and/or information associated with the modified channel map may be stored in one or more suitable memory devices associated with the profile server 125. For example, channel map information may be stored in a suitable user profile database. At block 335, information associated with the modified channel map, such as a copy of the modified channel map, information that may be utilized to construct the modified channel map, information associated with the modifications, and/or an identifier of the modified channel map, may be output by the profile server 125 for communication to one or more programming processing components 110 associated with the user.

At block 340, a determination may be made as to whether any additional modifications should be made to one or more channel maps associated with a customer. For example, a determination may be made as to whether updated user information is available. As another example, a determination may be made as to whether additional user requests have been received. If it is determined at block 340 that additional modifications should be made to one or more channel maps, then operations may continue at block 325 described above, and one or more preexisting channel maps associated with the customer may be modified. If, however, it is determined at block 340 that additional modifications should not be made, then operations may either end or, alternatively, enter a waiting state until updated information and/or user requests are received by the profile server 125.

The method, 300 may end following block 340.

FIG. 4 is a flow diagram of an example method 400 for modifying a channel map in response to a user request, according to an example embodiment of the invention. In certain embodiments, the operations of the method 400 may be one example of the operations that may be performed at block 325 of the method 300 illustrated in FIG. 3. As such, the method 400 may be performed by a suitable service provider system and/or profile server, such as the service provider system 105 and/or profile server 125 illustrated in FIG. 1. The method 400 may begin at block 405.

At block 405, information associated with a customer request to modify a preexisting channel map and/or customer parameters associated with modifying a preexisting channel may be received. In certain embodiments, customer requests and/or parameters may be provided by a user to a programming processing component, such as the programming processing component 110 illustrated in FIG. 1, and the programming processing component 110 may communicate the customer requests and/or parameters to the service provider system 105 via one or more suitable service provider networks (e.g., a cable network, a satellite network, etc.). In other embodiments, a user may utilize a suitable user device, such as the user device 135 illustrated in FIG. 1, to access a server (e.g., a Web server) hosted by the service provider, and user requests and/or parameters may be provided to the service provider via a communications session established between the server and the user device 135.

At block 410, stored channel map information for the customer may be accessed from memory. For example, information associated with one or more channel maps for the customer may be accessed from a user profile database, such as the user profile database 146 illustrated in FIG. 1. At block 415, a scope associated with a channel map modification may be determined. For example, a determination may be made as to whether one or more channel maps will be modified at a user or individual level, at a programming processing component level, at a customer account level, and/or at any other level. As desired, a modification scope may be determined prior to accessing stored channel map information. In this regard, the access of information may be limited to the stored information relevant to the modification.

At block 420, one or more channel maps for the customer may be modified based at least in part upon the received customer requests and/or parameters. In this regard, a customer may be permitted to customize and/or personalize one or more channel maps. As desired in various embodiments, a wide variety of different modifications may be made to a customer map in response to one or more user requests. For example, a user may be permitted to assign and/or re-organize channel numbers within a channel map. As another example, a user may be permitted to display and/or hide certain channels from a channel map. For example, adult channels may be included in a channel map accessible by adults (e.g., accessible for particular users, accessible by a programming processing component situated in a bedroom, etc.) and excluded in other channel maps. As another example, a user may request certain versions of a channel, such as a high-definition version of a channel. As desired, device capabilities of a programming processing component and/or subscriber level information may be utilized in order to determine whether user requested modifications will be implemented.

At block 425, which may be optional in certain embodiments of the invention, an identifier of the modified channel map may be generated. As desired, the generated identifier may be utilized by a programming processing component 110 to identify an appropriate channel map included in a broadband signal and to extract the channel map. As an alternative to utilizing a channel map identifier, the entire channel map may be communicated to the programming processing component 110 and/or stored in a memory associated with a programming processing component 110. At block 430, the generated identifier, the modified channel map, and/or information associated with the modified channel map may be stored by the profile server 125 in one or more suitable memory devices and/or memory locations, such as the user profile database 146. In this regard, the modified channel map may be accessed by the profile server 125 for additional modifications and/or for communication to a programming processing component 110.

The method 400 may end following block 430.

FIG. 5 is a flow diagram of an example method 500 for modifying a channel map based at least in part upon historical information and/or demographic information associated with a customer, according to an example embodiment of the invention. In certain embodiments, the operations of the method 500 may be one example of the operations that may be performed at block 325 of the method 300 illustrated in FIG. 3. As such, the method 500 may be performed by a suitable service provider system and/or profile server, such as the service provider system 105 and/or profile server 125 illustrated in FIG. 1. The method 500 may begin at block 505.

At block 505, information associated with a programming processing component associated with a customer, such as the programming processing component 110 illustrated in FIG. 1, may be identified and/or obtained. A wide variety of information associated with a programming processing component 110, such as a device identifier, device capabilities, and/or subscription level information, may be identified. In certain embodiments, the programming processing component information may be obtained from a suitable billing system, such as the billing system 120 illustrated in FIG. 1. In other embodiments, programming processing component information may be received from the programming processing component 110. For example, a status message output by the programming processing component 110 may be received.

At block 510, demographic and/or historical information associated with the customer may be identified. A wide variety of suitable information may be identified as desired in various embodiments of the invention. Examples of suitable demographic information include, but are not limited to, advertisement profile information, income-related information (e.g., median income information for a geographical area, etc.), gender information for a customer, household makeup information for a customer, etc. Examples of suitable historical information include, but are not limited to, viewing history information for a customer, transaction and/or purchase history information for a customer (e.g., pay-per-view purchase information, etc.), etc. indeed, a wide variety of different information may be identified and/or obtained in order to customize or modify a channel map for a customer.

At block 515, a determination may be made as to whether customer opt in information for advertisements and/or advertisement preferences is available. For example, a determination may be made as to whether a customer has provided advertisement preferences information via a programming processing component 110 (e.g., responding to displayed advertisement queries, etc.) and/or via one or more user devices, such as the user devices 135 illustrated in FIG. 1. In this regard, an advertisement profile for a customer may be customized and/or modified based upon information received from a user. If it is determined at block 515 that advertisement opt in and/or preferences information is not available, then operations may continue at block 525 described in greater detail below. If, however, it is determined at block 515 that opt in and/or preferences information is available, then operations may continue at block 520, and the opt in and/or preferences information may be identified, accessed, or otherwise obtained. Operations may then continue at block 525.

At block 525, a channel map for a customer may be modified based at least in part on device capabilities and/or device information, demographic information, history information, an advertisement profile, and/or customer advertisement preferences. In this regard, a channel map may be personalized and/or customized by the profile server 125 for a wide variety of service provider purposes, such as targeting advertisement information that may be presented to a customer.

A wide variety of different types of modifications may be made to a channel map as desired in various embodiments of the invention. For example, a version of a channel or type of a channel that is included in a channel map may be modified. As one example, a service provider may include multiple versions of the same channel in a broadband signal. The various versions may include different formats, codecs, source constructs, and/or advertisement information. The version of the channel included in a channel map for the user may be identified based upon at least a portion of the information discussed above, such as an advertisement profile, viewing history, and/or demographic information.

At block 530, which may be optional in certain embodiments of the invention, an identifier of the modified channel map may be generated. As desired, the generated identifier may be utilized by a programming processing component 110 to identify an appropriate channel map included in a broadband signal and to extract the channel map. As an alternative to utilizing a channel map identifier, the entire channel map may be communicated to the programming processing component 110 and/or stored in a memory associated with a programming processing component 110. At block 535, the generated identifier, the modified channel map, and/or information associated with the modified channel map may be stored by the profile server 125 in one or more suitable memory devices and/or memory locations, such as the user profile database 146. In this regard, the modified channel map may be accessed by the profile server 125 for additional modifications and/or for communication to a programming processing component 110.

The method 500 may end following block 535.

The operations described and shown in the methods 300, 400, and 500 of FIGS. 3-5 may be carried out or performed in any suitable order as desired in various embodiments of the invention. Additionally, in certain embodiments, at least a portion of the operations may be carried out in parallel. Furthermore, in certain embodiments, less than or more than the operations described in FIGS. 3-5 may be performed.

Various block and/or flow diagrams of systems, methods, apparatus, and/or computer program products according to example embodiments of the invention are described above. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention.

These computer-executable program instructions may be loaded onto a special purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special purpose, hardware-based computer systems that perform the specified functions, elements or steps, or combinations of special purpose hardware and computer instructions

Many modifications and other embodiments of the invention set forth herein will be apparent having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A system comprising:
at least one memory configured to store computer-executable instructions; and
at least one processor configured to access the at least one memory and execute the computer-executable instructions to:
identify a predetermined channel map for a customer of a service provider, the predetermined channel map comprising information mapping at least one of frequencies and program identifiers included in a broadband communications signal to a plurality of channels, wherein the broadband communications signal is output by the service provider;
modify, based upon information associated with the customer, the predetermined channel map;
direct the output of information associated with the modified channel map for communication via a service provider network to a programming processing component associated with the customer.

2. The system of claim 1, wherein the predetermined channel map comprises a default channel map for the customer identified based at least in part upon information received from a billing system of the service provider.

3. The system of claim 1, wherein the predetermined channel map is modified based upon at least one of (i) demographic information or (ii) historical information associated with the customer.

4. The system of claim 3, wherein at least one of (i) a version of a channel or (ii) a type of channel is modified.

5. The system of claim 1, wherein the predetermined channel map is modified based upon a received customer request to modify the predetermined channel map.

6. The system of claim 5, further comprising:
at least one communications interface configured to receive, via a network from a user device associated with the customer, the customer request to modify the predetermined channel map.

7. The system of claim 5, wherein at least one of (i) channel organization, (ii) channel number assignments, (iii) visible channels, or (iv) a customer advertisement profile associated with the predetermined channel map is modified.

8. The system of claim 1, wherein the predetermined channel map is modified for one of (i) a location associated with the customer, (ii) a programming processing component associated with the customer, or (iii) an individual user associated with a customer account.

9. A method comprising:
identifying, by a profile server associated with a service provider and comprising one or more computers, information associated with a predefined channel map for a customer of the service provider, the predefined channel map comprising at least one of frequencies and program identifiers included in a broadband communications signal to a plurality of channels, wherein the broadband communications signal is output by the service provider;
receiving, by the profile server, information associated with a customer request to modify the predefined channel map;
modifying, by the profile server based at least in part upon the received information, the predefined channel map; and
outputting, by the profile server for communication via a service provider network to a programming processing component associated with the customer, at least an identifier of the modified channel map.

10. The method of claim 9, wherein identifying a predefined channel map comprises identifying one of (i) a default channel map for the customer based at least in part upon information received from a billing system of the service provider or (ii) a stored customized channel map for the customer.

11. The method of claim 9, wherein receiving information associated with a customer request comprises receiving information output by one of (i) a programming processing component associated with the customer or (ii) an Internet-enabled device associated with the customer.

12. The method of claim 9, wherein modifying the predefined channel map comprises modifying at least one of (i) channel organization, (ii) channel number assignments, (iii) visible channels, or (iv) a customer advertisement profile associated with the predefined channel map.

13. The method of claim 9, wherein modifying the predefined channel map comprises modifying the predefined channel map for one of (i) a location associated with the customer, (ii) a programming processing component associated with the customer, or (iii) an individual user associated with a customer account.

14. The method of claim 9, further comprising:
modifying, by the profile server based upon at least one of (i) demographic information associated with the customer or (ii) historical information associated with the customer, the predefined channel map.

15. The method of claim 9, wherein outputting at least an identifier of the modified channel map comprises outputting at least an identifier in response to a request for channel map information received from a programming processing component associated with the customer.

16. A method comprising:
identifying, by a profile server associated with a service provider and comprising one or more computers, information associated with a predefined channel map for a customer of the service provider, the predefined channel map comprising at least one of frequencies and program identifiers included in a broadband communications signal to a plurality of channels, wherein the broadband communications signal is output by the service provider;
modifying, by the profile server based at least in part upon one of (i) demographic information associated with the customer or (ii) historical information associated with the customer, the predefined channel map; and
outputting, by the profile server for communication via a service provider network to a programming processing component associated with the customer, at least an identifier of the modified channel map.

17. The method of claim 16, wherein identifying a predefined channel comprises identifying one of (i) a default channel map for the customer based at least in part upon information received from a billing system of the service provider or (ii) a stored customized channel map for the customer.

18. The method of claim 16, wherein modifying the predefined channel map comprises modifying at least one of (i) a version of a channel associated with the channel map or (ii) a type of a channel associated with the channel map.

19. The method of claim 16, further comprising:
receiving, by the profile server, information associated with a customer request to modify the predefined channel map;
wherein modifying the predefined channel map comprises modifying the predefined channel map based at least in part on the received information associated with the customer request.

20. The method of claim 19, wherein receiving information associated with a customer request comprises receiving a customer preference associated with advertisement information to be presented to the customer.

21. The method of claim 16, wherein modifying the predefined channel map comprises modifying the predefined channel map for one of (i) a location associated with the customer, (ii) a programming processing component associated with the customer, or (iii) an individual user associated with a customer account.

22. The method of claim 16, wherein outputting at least an identifier of the modified channel map comprises outputting at least an identifier in response to a request for channel map information received from a programming processing component associated with the customer.
